(19) United States
(12) Patent Application Publication
(10) Pub. No.: US 2025/0384667 A1
(43) Pub. Date: Dec. 18, 2025

(54) MACHINE LEARNING SYSTEM AND METHOD

(71) Applicant: Ford Global Technologies, LLC, Dearborn, MI (US)

(72) Inventors: Stefan Lee, Corvallis, OR (US); Akhil Perincherry, Corvallis, OR (US)

(73) Assignee: Ford Global Technologies, LLC, Dearborn, MI (US)

(21) Appl. No.: 18/746,657

(22) Filed: Jun. 18, 2024

(51) Int. Cl. G06V 10/774; G06V 10/776; G06V 10/82; G06V 20/56

(52) U.S. Cl. CPC G06V 10/774; G06V 10/776; G06V 10/82; G06V 20/56

(57) ABSTRACT

A computer that includes a processor and a memory, the memory including instructions executable by the processor to generate a training dataset that includes images that are outside an operational design domain of a machine learning system by modifying the images by adding Perlin noise, wherein the machine learning system is trained to detect an object in an acquired image. The neural network can be retrained to output a confidence value greater than a threshold when an image is determined to be inside the operational design domain based on the generated training dataset.

### BACKGROUND

Computers can operate systems and devices including vehicles, robots, drones, and/or object tracking systems. Data including images can be acquired by sensors and processed by a computer to determine a location of a system with respect to an environment and with respect to objects in the environment. A computer may use the location data to determine one or more trajectories and/or actions for operating the system or components thereof in the environment.

### BRIEF DESCRIPTION OF THE DRAWINGS

FIG. 1 is a block diagram of an example vehicle system.

FIG. 2 is a diagram of an example vehicle including a camera.

FIG. 3 is a diagram of an example image of a traffic scene.

FIG. 4 is a diagram of an example image of a traffic scene including soiling.

FIG. 5 is a diagram of an example machine learning system.

FIG. 6 is a diagram of an example system to train a machine learning system based on Perlin noise.

FIG. 7 is a diagram of example Perlin noise.

FIG. 8 is another diagram of example Perlin noise.

FIG. 9 is another diagram of example Perlin noise.

FIG. 10 is a flowchart diagram to operate a vehicle based on a trained neural network.

### DETAILED DESCRIPTION

Systems that move and/or that have mobile components, including vehicles, robots, drones, cell phones etc., can be operated by acquiring sensor data, including data regarding an environment around the system, and processing the sensor data to determine locations of objects in the environment around the system. The determined location data could be processed to determine operation of the system or portions of the system. For example, a robot could determine the location of another nearby robot's arm. The determined robot arm location could be used by the robot to determine a path upon which to move a gripper to grasp a workpiece without encountering the other robot's arm. In another example, a vehicle could determine a location of another vehicle traveling on a roadway. The vehicle could use the determined location of the other vehicle to determine a path upon which to operate while maintaining a predetermined distance from the other vehicle. Vehicle operation will be used herein as a non-limiting example of system location determination in description below.

A machine learning system, for example a convolutional neural network, can be trained to determine identities and locations of one or more objects included in the environment, for example roadways and vehicles. Convolutional neural networks include convolutional layers and fully connected layers and can be trained to identify and locate objects. Training a convolutional neural network can require a training dataset that can include thousands of video sequences that can include millions of images. In addition, training a machine learning system such as a convolutional neural network can require ground truth data for the images in the training dataset. Ground truth includes annotation data regarding the identities and locations of objects included in the training dataset acquired from a source other than the machine learning system, for example user annotation of the images in the training dataset.

A trained machine learning system such as a convolutional neural network can be installed in a computing device in a vehicle to receive sensor data from sensors included in the vehicle. The machine learning system can determine predictions regarding the received sensor data to assist in operating the vehicle. For example, a trained convolutional neural network can be trained to receive images from video cameras and determine predictions regarding an environment around a vehicle. Predictions can include determining the location and motion of the vehicle with respect to the environment and location and motion of objects in the environment.

Obtaining accurate results from a trained machine learning system can depend upon the input data being similar to the data included in the training dataset. Accurate results are defined as obtaining similar results at inference time as were obtained during training, e.g., a vehicle should be detected by the trained machine learning system at inference time if a similar vehicle at a similar size and location in the training dataset was detected at inference time by the machine learning system. Similar size and location, in this context, means within a small percentage, e.g. 5-10%, of the size and location from the training dataset. Obtaining accurate results can depend upon environmental conditions under which the image data was acquired being similar to the environmental conditions included in the training dataset. Similar environmental conditions mean the images include similar types of objects (buildings, roadways, etc.) in similar orientations, e.g., roadways on a ground plane with adjacent structures or foliage, and lighting and weather similar to the training dataset. Similar lighting and weather in this context mean within a few percent (e.g., 5-10%) of the brightness and contrast with similar detail, e.g., edge strength defined by a directional derivative perpendicular to the edge being at least 10% of the full pixel scale. The environmental conditions of a training dataset can be summarized as the operational design domain (ODD) of a trained machine learning system as defined below. Objects included in acquired images that are inside the ODD of a machine learning system, meaning that the environmental conditions included in the image are within the limits as defined below for the machine learning system can be expected to be detected successfully with high (e.g., >90%) probability. Objects included in acquired images that are outside the ODD, meaning that the environmental conditions included in the images are not within the limits as defined below for the machine learning system, can be expected to be detected with lower confidence (e.g., <90% probability).

The ODD is defined as the operating context for a machine learning system. The operating context of a machine learning system includes variable conditions that can change the appearance of objects to be detected by the machine learning system. Changing the appearance of objects from the appearance of the object in the training dataset can reduce the probability that the machine learning system will correctly detect an object. Examples of environmental conditions included in the ODD of a machine learning system can include, but are not limited to, camera soiling, background, weather, lighting, and noise. Camera soiling can include foreign materials such as dirt, mud, dust, or raindrops on a camera lens or camera lens cover. Background conditions can include indoor locations, outdoor locations and the roadways, ground, structures and foliage that can be present in the locations. Weather conditions can include precipitation, which can include rain, snow, etc., and atmospheric conditions such as mist, fog or dust. Lighting conditions can include time of day, e.g., night or day, direct or indirect sunlight including overcast conditions, and various types of artificial light. Noise can include soiling, which includes material that obscures the camera lens or transparent lens covering, and electronic noise included in the acquired data. Electronic noise can be random, e.g., salt-and-pepper noise, or structured, e.g., dropouts, missing lines, etc.

ODD includes environmental conditions that can reduce the ability of a machine learning system to detect objects, where detecting an object can include determining an object's location, orientation, size, and identity. ODD can be defined by specifying the environmental conditions that are included in the ODD based on the appearance of objects in the acquired image data. The appearance of objects can be specified by the contrast ratio, which is the ratio of the average pixel luminance of the object to the average luminance of the surrounding background. The appearance of objects can also be defined by the details internal to the object specified by the strength of lines and edges in the object as defined above. The appearance of objects also includes the strength of the silhouette that separates the object from the background. A silhouette in the present context means the shape formed by the edges that surround an object. The strength of a silhouette is the strength of the edges, as defined above, that form the silhouette. Acquired images that include environmental conditions that are inside the ODD can have a high enough contrast ratio to permit a machine learning system to detect an object included in the image. Acquired images that include environmental conditions that are outside the ODD may not have a high enough contrast ratio to permit a machine learning system to detect an object.

The camera soiling conditions that are included in the ODD can be defined in terms of the appearance of objects. For example, camera soiling can be a function of mud being splashed onto the camera, or dust settling on specific points on the camera lens or lens cover. The patterns of soiling on the camera often are a function of camera hardware characteristics, hydrophobic coating on the camera lens, etc. Camera lens soiling can obscure all or portions of an object, reducing the probability that a machine learning system can detect the object.

The limits or “corners” of the ODD can be determined for environmental conditions, including combinations of environmental conditions, by assembling a library of test images that include objects acquired under a wide variety of environmental conditions and testing them by inputting them to a trained machine learning system to determine what types of environmental conditions and combinations of environmental conditions cause the machine learning system to not detect objects. Environmental conditions included in images that are successfully processed, e.g., objects are correctly detected, are inside the ODD, and environmental conditions included in images that are not successfully processed, e.g., objects are not correctly detected, are outside the ODD.

Other techniques for determining corners of the ODD include tagging data samples that a machine learning algorithm performs poorly on. A human can then validate the representative samples for each case to annotate samples as inside the ODD or not inside the ODD. Human validation can be required for this technique because not all of the samples perform poorly on is because of the ODD. Human validation can be required to distinguish between poor model performance and ODD.

Techniques for ODD detection described herein enhance object detection by machine learning systems by detecting when an acquired image is outside the ODD due to camera lens soiling. Camera lens soiling in this context includes both camera lens soiling and camera lens cover soiling. A trained object detection machine learning system can be retrained to determine a confidence value that a received image is inside the ODD while the machine learning system detects objects. The confidence value can be output along with a prediction regarding the detected object. The system receiving the object prediction can compare the confidence value to a predetermined threshold to determine whether to rely on the prediction or not. For example, if the confidence value is less than 90%, the system can acquire another image and try again, increase lighting values, e.g., turn on bright lights, alert a user that the object detection results have low confidence, or undertake all of the preceding actions.

In other techniques, a stand-alone machine learning system can be determined using techniques described below to classify whether an input image is inside the ODD or not. Variants of this technique include a stand-alone machine learning system that performs a granular classification where the model predicts if an input image is obstructed from dirt, lighting, haze etc. Another variant would be to perform a grid based classification of regions in the image.

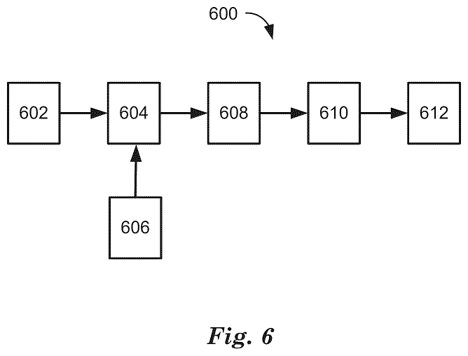

Camera lens soiling is simulated by generating camera soiling textures using a Perlin noise generator software program. Perlin noise is generated based on parameters that determine splotch size, splotch sharpness, splotch transparency, and splotch color. These parameters are described below in relation to FIG. 6. When testing a trained machine learning system to determine the ODD, real world camera soiling images can be used. The statistical distributions and lower limits on the Perlin noise parameters that cause the machine learning system to underperform are referred to as “corner cases” and are used to generate Perlin noise to be added to real world images to retrain the machine learning system to detect whether the image is inside or outside the ODD. The machine learning system can be retrained using the distributions of Perlin noise parameters as ground truth to determine ODD confidence values that predict the confidence that the machine learning system can correctly detect an object in a given input image.

A techniques that can be used to determine corner cases for ODD include gradient based optimization. Gradient based optimization can include generating images from starting Perlin parameters. Perlin parameters are described below in relation to FIG. 6. Starting Perlin parameters can be initialized randomly. A loss function can be defined that minimizes the discrepancy between generated and real world soiled image. For example the loss function can be defined by the equation: Loss=−(Noise_area−lambda*L1(abs(real_world_soiled−perlin_soiled))). A gradient descent can be performed on the loss function to estimate the Perlin parameters that minimizes the loss function. Gradient descent on the Perlin noise parameters can be repeated until convergence or a maximum number of iterations.

In other techniques, the Perlin noise parameters are determined by humans inspecting images based on systems engineering documents that specify the percentage and areas of images that can be obscured by camera soiling and remain inside the ODD. Human inspectors can fine-tune the process of determining the Perlin noise parameters using this technique.

Disclosed herein is a method, including generating a training dataset that includes images that are outside an operational design domain of a machine learning system by modifying the images by adding Perlin noise, wherein the machine learning system is trained to detect an object in an acquired image. The machine learning system can be retrained to output a confidence value greater than a threshold when an image is determined to be inside the operational design domain based on the generated training dataset. The operational design domain of the machine learning system can include environmental conditions included in the images received by the machine learning system. The environmental conditions can include background, weather, lighting, and noise. Environmental conditions included in the image can be inside the operational design domain when the machine learning system can detect the object. The environmental conditions included in the image can be outside the operational design domain when the machine learning system does not detect the object. The Perlin noise can be used to simulate camera lens soiling.

The operational design domain can be determined by testing the machine learning system using images that include camera lens soiling that is inside the operational design domain and camera lens soiling that is outside the operational design domain. The machine learning system can be a convolutional neural network that includes convolutional layers and fully connected layers. Distributions of parameters that describe the distributions of Perlin noise parameters including one or more of splotch size, splotch sharpness, splotch transparency and color can be used to determine camera lens soiling included in a training dataset. The statistical distributions of parameters that describe the distributions of Perlin noise can be determined by gradient descent. A second computer can be included in a vehicle that is programmed to execute the retrained machine learning system to receive the acquired image from a sensor included in a vehicle and determine a confidence value regarding the operational design domain and detect the object. The second computer included in the vehicle can be programmed to operate the vehicle based on the detected object. The splotch size can be controlled by inversely relating the number of octaves and size. The splotch sharpness can be controlled by applying a non-linear function including one or more of a hyperbolic tangent and a sigmoid function.

Further disclosed is a computer readable medium, storing program instructions for executing some or all of the above method steps. Further disclosed is a computer programmed for executing some or all of the above method steps, including a computer apparatus, programmed to generate a training dataset that includes images that are outside an operational design domain of a machine learning system by modifying the images by adding Perlin noise, wherein the machine learning system is trained to detect an object in an acquired image. The machine learning system can be retrained to output a confidence value greater than a threshold when an image is determined to be inside the operational design domain based on the generated training dataset. The operational design domain of the machine learning system can include environmental conditions included in the images received by the machine learning system. The environmental conditions can include background, weather, lighting, and noise. Environmental conditions included in the image can be inside the operational design domain when the machine learning system can detect the object. The environmental conditions included in the image can be outside the operational design domain when the machine learning system does not detect the object. The Perlin noise can be used to simulate camera lens soiling.

The instructions can include further instructions to determine the operational design domain by testing the machine learning system using images that include camera lens soiling that is inside the operational design domain and camera lens soiling that is outside the operational design domain. The machine learning system can be a convolutional neural network that includes convolutional layers and fully connected layers. Distributions of parameters that describe the distributions of Perlin noise parameters including one or more of splotch size, splotch sharpness, splotch transparency and color can be used to determine camera lens soiling included in a training dataset. The statistical distributions of parameters that describe the distributions of Perlin noise can be determined by gradient descent. A second computer can be included in a vehicle that is programmed to execute the retrained machine learning system to receive the acquired image from a sensor included in a vehicle and determine a confidence value regarding the operational design domain and detect the object. The second computer included in the vehicle can be programmed to operate the vehicle based on the detected object. The splotch size can be controlled by inversely relating the number of octaves and size. The splotch sharpness can be controlled by applying a non-linear function including one or more of a hyperbolic tangent and a sigmoid function.

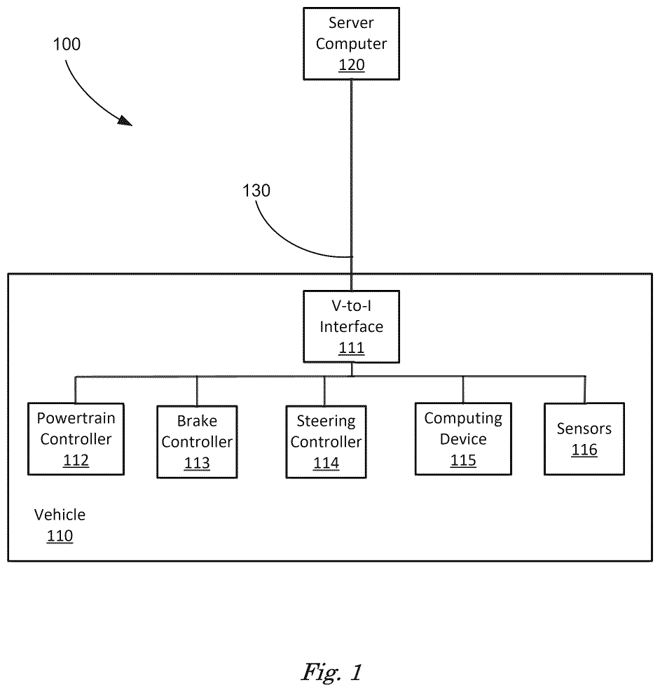

FIG. 1 is a diagram of vehicle computing system 100. Vehicle computing system 100 includes a vehicle 110, a computing device 115 included in the vehicle 110, and a server computer 120 remote from the vehicle 110. One or more vehicle 110 computing devices 115 can receive data regarding the operation of the vehicle 110 from sensors 116. The computing device 115 may operate vehicle 110 based on data received from the sensors 116 and data received from the remote server computer 120. The server computer 120 can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of speed in the vehicle 110 by controlling one or more of an internal combustion engine, electric motor, hybrid engine, etc.), steering, climate control, interior and exterior lights, etc., as well as to determine whether and when the computing device 115, as opposed to a human operator, is to control such operations. The computing device 115 can also control the temporal alignment of lighting to sensor acquisition to account for the color effects of vehicle lights or external lights.

The computing device 115 may include or be communicatively coupled to, i.e., via a vehicle communications bus as described further below, more than one computing devices, i.e., controllers or the like included in the vehicle 110 for monitoring and controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in vehicle 110 and receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2I) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and wireless networking technologies, i.e., cellular, BLUETOOTH®, Bluetooth Low Energy (BLE), Ultra-Wideband (UWB), Peer-to-Peer communication, UWB based Radar, IEEE 802.11, and other wired and wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range

Communications (DSRC) and the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2I) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and control various vehicle 110 components and operations. For example, the computing device 115 may include programming to control vehicle 110 operational behaviors (i.e., physical manifestations of vehicle 110 operation) such as speed, steering, etc., as well as tactical behaviors (i.e., control of operational behaviors typically in a manner intended to achieve efficient traversal of a route) such as a distance between vehicles and amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and other sensors 116 and the geographical coordinates provided by the GPS sensor may be used by the computing device 115 to operate the vehicle 110 autonomously or semi-autonomously, for example.

The vehicle 110 is generally a land-based vehicle 110 capable of autonomous and semi-autonomous operation and having three or more wheels, i.e., a passenger car, light truck, etc. Vehicle 110 includes one or more sensors 116, the V2I interface 111, the computing device 115 and one or more controllers 112, 113, 114. Sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power applied to controllers 112, 113, 114 in the vehicle 110, connectivity between components, and accurate and timely performance of components of the vehicle 110.

Server computer 120 typically has features in common, e.g., a computer processor and memory and configuration for communication via a network 130, with the vehicle 110 V2I interface 111 and computing device 115, and therefore these features will not be described further to reduce redundancy. A server computer 120 can be used to develop and train software that can be transmitted to a computing device 115 in a vehicle 110.

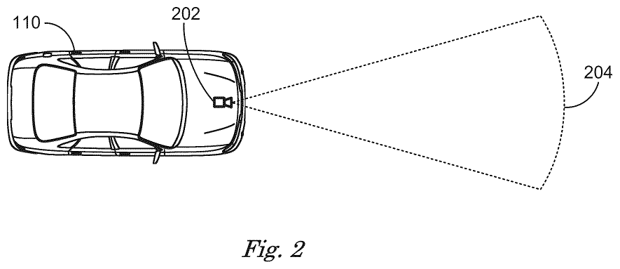

FIG. 2 is a diagram of vehicle 110 including a camera 202 having a field of view 204. A camera field of view 204 is a space in an environment around a vehicle within which the camera can obtain images. Acquired images can be received by a machine learning system included in a computing device 115 and processed to determine predictions regarding objects included in an environment around vehicle 110. Predictions determined by a machine learning system can include predictions regarding an identity of an object such as a roadway or a vehicle included in the environment and a location, orientation and size of an object with respect to vehicle 110.

By determining machine learning system predictions regarding objects, computing device 115 can determine a vehicle path upon which to operate vehicle 110. A vehicle path can be described by a polynomial function (which may be referred to as a “path polynomial”) based on limits on rates of change in lateral and longitudinal speeds. Vehicle 110 can be directed to operate on the vehicle path by computing device 115 issuing commands to controllers 112, 113, 114, to actuate vehicle components. Techniques described herein can enhance the operation of vehicle 110 by computing device 115 by determining a confidence value regarding whether an acquired image is inside the ODD. When computing device 115 receives a value from the machine learning system indicating that the received image has a high confidence of being inside a determined OOD, computing device 115 can proceed with operation of the vehicle based on the prediction regarding the object being determined with high confidence.

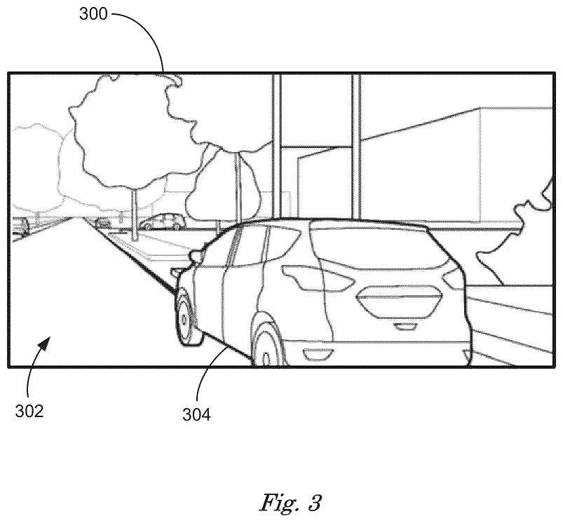

FIG. 3 is an example diagram of an image 300 of a traffic scene. Image 300 can be acquired by a camera 202 included in a vehicle 110, for example. Image 300 includes a roadway 302 and vehicle 304. By inputting the acquired image 300 to a machine learning system, computing device 115 can determine predictions regarding the identities and locations of roadway 302 and vehicle 304, and can determine a vehicle path that would permit vehicle 110 to operate on roadway 302 by actuating vehicle components via controllers 112, 113, 114. Based on techniques described herein, computing device 115 can operate vehicle 110 with high confidence because the machine learning system has determined that the image 300 is inside the OOD determined for the machine learning system.

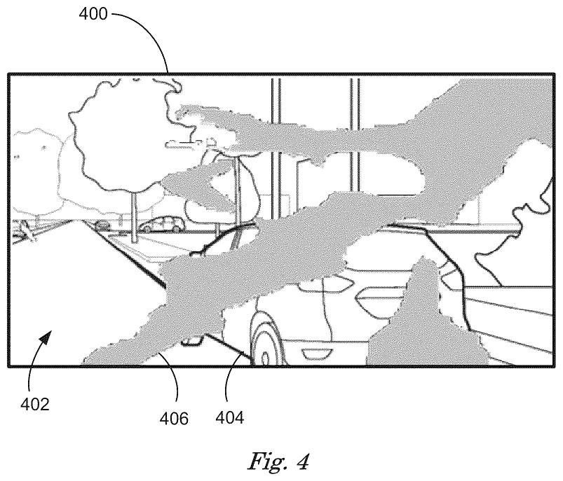

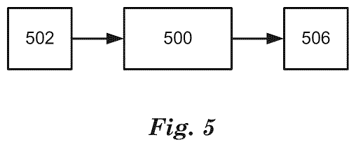

FIG. 4 is an example diagram of an image 400 of a traffic scene. Image 400 can be acquired by a camera 202 included in a vehicle 110, for example. Image 400 includes roadway 402 and vehicle 404. Image 400 also includes soiling 406 on camera 202 lens or lens cover. Soiling 406 on camera 202 lens or lens cover can cause image 400 to be outside the determined OOD for a machine learning system 500 (FIG. 5). Technique described herein for determining whether images 400 are inside the ODD can determine that image 400 has low confidence of being inside the ODD, and object predictions, for example a location of vehicle 404, output from the machine learning system 500 (FIG. 5) can likewise have a low confidence of being accurate.

FIG. 5 is a diagram of a machine learning system 500. Machine learning system 500 is a software program that can be developed and trained on a server computer 120 and transmitted to a computing device 115 included in a vehicle 110. In this example machine learning system 500 is a convolutional neural network (CNN) that can input an image 502 generated by vehicle sensors 116 and output object predictions 506 which can include object identities, locations, sizes, and orientations, for example. Vehicle sensor data can include images 502 of the environment around a vehicle 110 as it travels on a roadway. Machine learning system 500 can include other types of machine learning software programs other than a CNN including generative adversarial networks (GANs), capsule networks, support vector machines (SVMs), and rule-based machine learning systems.

Machine learning system 500 can be a CNN that can include a plurality of convolutional layers that input image data and convolve the image data with convolutional kernels that extract features from the image data. The extracted features can be passed as hidden or latent variables to a plurality of fully connected layers that detect objects such as vehicles in the hidden or latent variables and output object predictions 506. Machine learning system 500 can be trained to output object predictions 506 for operating a vehicle 110 by generating images 502 of traffic scenes to assemble a training dataset of images 502 that include objects such as nearby vehicles along with ground truth data for the images 502. Ground truth data, which means data intended or believed to describe real-world conditions, can include identities, locations, sizes, and orientations for objects included in the images 502 in the training dataset determined by human observers or software programs provided to generate ground truth data.

At training time, images 502 from the training dataset can be passed through machine learning system 500 to generate predictions 506 a plurality of times. Each time an image 502 is passed through the machine learning system 500, the output prediction 506 is compared with the ground truth for that image 502 and a loss function determined. A loss function can measure the difference between an output prediction 506 and the ground truth, with the goal being to minimize the difference. The loss function can be minimized by backpropagation of the loss function through the machine learning system 500. Backpropagation is a technique for selecting the weights which program each layer of the neural network from back (output) to front (input). The weights which result in the loss function converging on a global or local minimal value based on iterating through the complete training dataset, often multiple times, until the model converges.

FIG. 6 is an example ODD retraining system 600. ODD retraining system 600 can retrain a machine learning system 500 that has been previously trained to detect objects in image data to determine a confidence value that an input image is inside an ODD. The confidence value will be measured with respect to the type of deviation from the ODD that was present in distributions of camera lens soiling included in the training dataset. Camera lens soiling is the deviation from an ODD that is included in the training dataset. As a result, camera lens soiling is the only deviation from the ODD that ODD retraining system 600 would retrain a machine learning system to detect. As described above, image ODD for a machine learning system 500 can be a function of multiple sources of deviation, including weather, lighting, and/or noise.

Other sources of deviation from image ODD can be simulated and handled by ODD retraining systems that are configured to produce training datasets that include images that are inside the ODD and are outside the ODD as determined by a trained machine learning system 500 trained to detect objects. Sources of deviation from ODD can be found in existing training datasets or simulated by techniques such as generative adversarial networks (GANs) or diffusion models. GANs are neural networks that can be trained to add weather and lighting changes to images. GANs can require large datasets of sample images to train, but once trained, can be used to modify existing training datasets to simulate weather and lighting conditions inside and outside of an ODD. The modified images can then be used in an ODD retraining system similar to ODD retraining system 500 to retrain a machine learning system 500 to determine confidence values that an input image is inside an ODD with respect to weather and lighting conditions.

Diffusion models are another type of software program that can be used to simulate noise in image data. Diffusion models are algorithms that add Gaussian noise to image data repeatedly at different scales and different timesteps. Gaussian noise can simulate different type of noise found in image data. Diffusion models can be used to add Gaussian noise to images in a training dataset to simulate the effects of noise in image data. Training datasets that include image data modified by the addition of Gaussian noise can be used to retrain a machine learning system 500 to output a confidence value that an input image is inside an ODD with respect to electronic noise using an ODD retraining system similar to ODD retraining system 600.

ODD retraining system begins at ODD analysis 602, where a machine learning system is analyzed to determine the ODD with respect to camera lens soiling by a testing program executing on a server computer 120, for example. The testing program can access a database that includes thousands or millions of images that include objects and ground truth regarding the objects that have been acquired in all types of environmental conditions to determine which images will cause the machine learning system to not detect objects. The testing program can then perform further testing on the images that cause the machine learning program to not detect objects and analyze the images that include camera lens soiling.

Camera lens soiling can be detected and analyzed using machine vision software. An example of machine vision software is the OpenCV software library, available on the OpenCV.org website as of the filing date of this application. The OpenCV library includes routines that segment images, for example. Image segmentation can divide images into regions based on color, edges, and size of contiguous pixel regions inside the image. Camera lens soiling regions can be determined by consistency despite moving background or changing lighting, for example. The camera lens soiling regions can be further analyzed by OpenCV routines to determine soiling statistics including soiling type, e.g., mud, grass, dust, ice, etc., sharpness, which is a measure of spatial frequency and can be rated on scale from 1-20, for example, translucency, which is a measure of percent light transmission, and size, which measures the number of pixels included in each region of camera soiling. The camera lens soiling can be analyzed to determine Perlin noise parameters, as defined below, that could be used to generate the camera lens soiling detected by the image processing software. The testing program can compile statistical distributions for Perlin noise parameters, including mean and standard deviation for the camera lens soiling images and based on the statistical distributions, determine lower limits for the Perlin noise parameters that cause the machine learning system to underperform. The lower limits on underperformance for these parameters indicate the corner cases that define the ODD statistics for camera lens soiling for the machine learning system.

The underperforming images can indicate corner cases that define the ODD statistics for camera soiling for a machine learning system but in general do not include enough examples of camera soiling both inside and outside the ODD to permit retraining a machine learning system. The testing program may have detected a few images that cause underperformance due to camera lens soiling, while many thousands of images that include camera lens soiling with a variety of soiling that includes many different soiling types, sharpness's, and sizes can be required to retrain a machine learning system. Techniques described herein for retraining machine learning systems can enhance retraining because they can generate the thousands of camera soiling images along with ground truth data based on the ODD parameter distributions for retraining a machine learning system to output confidence values regarding the camera soiling ODD.

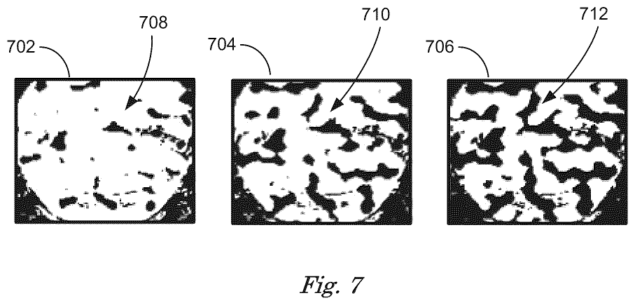

Perlin noise generation 604 receives the ODD statistics for camera lens soiling output by ODD analysis 602 along with an input training dataset 606 of images and ground truth. The training dataset 606 can be the training dataset 606 that was used to train the machine learning system to detect objects, for example. Perlin noise generation 604 receives the ODD analysis 602 and the training dataset and generates an ODD training dataset 608 based on the ODD statistics and the training dataset 606. Perlin noise generation 604 can generate multiple images for each image in the training dataset by adding multiple values of Perlin noise based on noise parameters derived from the ODD statistics. Noise parameters include splotch size, splotch sharpness, splotch translucency, and splotch color. Examples of camera soiling images generated according to the noise parameters are included in FIGS. 7-9.

An algorithm for generating Perlin noise is included in “An Image Synthesizer”, Ken Perlin, ACM SIGGRAPH Computer Graphics, Volume 19, Issue 3, pp 287-296. Perlin noise was developed to generate natural looking textures such as clouds, landscapes, and patterned textures such as marble for computer animation. Perlin noise can be generated by an algorithm that generated textures based on an input parameter octaves. The octaves parameter controls the number of times the Perlin noise algorithm repeats the generation of noise textures. Each iteration of noise texture generation adds noise textures with higher frequency, e.g., smaller size, at lower amplitude, e.g., lower pixel values. The Perlin noise algorithm Perlin() generates noise, which is an image that includes the Perlin noise based on the input parameter octaves as in equation (1):

noise=Perlin(octaves) (1)

Splotch size can be controlled by inversely relating the number of octaves and size. This relationship is based on the observation that, in the Perlin noise algorithm, higher octaves make splotch edges less smooth and smaller in size while lower octaves make larger, smoother splotches. This can be accomplished by determining the octaves parameter according to equation (2):

$$noise = Perlin ( octaves = {splotch}_{size} ) + 0.125 * Perlin ( octaves = 3 * splotch\_size ) \qquad ( 2 )$$

Splotch sharpness can be controlled by applying a non-linear function such as hyperbolic tangent or a sigmoid function to the output noise image to widen the neighboring edge intensities. Widening the neighboring edge intensities can result in sharpening the output noise splotches which can indicates a dirt or mud layer in the output camera lens soiling image according to equation (3);

$$noise = tanh ( max ( 0 , splotch\_sharpness * noise ) ) \qquad ( 3 )$$

Edge translucency is a property of real world camera lens soiling images that can be achieved by applying a color fading calculation to the pixels of the noise image using a color constant colorfade slightly less than a value of 1.0, for example 0.9. brightness is a new value for the pixels of image noise, which includes the image noise splotches in equation (4):

$$brightness = ( 1 - {noise}^{colorfade} ) \qquad ( 4 )$$

The color of camera lens soiling can vary depending upon the type of soiling present. Mud/dirt soiling tends to be black or shades of brown depending upon the thickness of the soiling. Haze, rain drops, etc., can vary widely in color depending upon the source of soiling. Techniques described herein can simulate any RGB value based on the application requirements under the control of the algorithm generating the soiling. Color can be applied to the splotches included in image noise by applying a selected RGB value to the greyscale value of the noise image. The RGB value can be applied, and the noise image applied to an image im from the training dataset by equation (5);

$$im = ( 1 - noise ) * im + ( noise * brightness * color ) \qquad ( 5 )$$

Based on the received ODD statistics, Perlin noise generation 604 can input images from the training dataset 606 and add multiple types of Perlin noise to modify the images. The parameters described above in relation to equation 2-5 can be varied to generate multiple examples of an image modified with Perlin noise that is some of which are inside the ODD and some of which are outside the ODD to generate a Perlin noise training dataset 608.

The Perlin noise training dataset 608 is then received by machine learning retraining 610. Machine learning retraining 610 is a software program or module that includes a copy of a machine learning system 500 that has been trained to detect an object. The trained machine learning system 500 to be retrained to determine a confidence value that an input image 502 is inside the ODD in addition to detecting objects. Machine learning retraining 610 can retrain a machine learning system 500 to determine a confidence value that an image in the Perlin noise dataset 608 is inside the ODD by determining a loss function that compares the detection results and output confidence value with ground truth data and data regarding the Perlin noise parameters. The loss function can be backpropagated through the machine learning system to determine weights that will be included in an output retrained machine learning system 612.

FIG. 7 is an example diagram of three Perlin noise images 702, 704, 706 that include Perlin noise. Image 702 includes Perlin noise generated with parameters size=0.05, sharpness=5. Image 704 includes Perlin noise generated with parameters size=0.05, sharpness=10. Image 706 includes Perlin noise generated with parameters size=0.05, sharpness=20. Perlin noise images 702, 704, 706 can be combined with images from a training dataset 606 to generate images for retraining a machine learning system 500 to output confidence values that the input image is inside a camera lens soiling ODD.

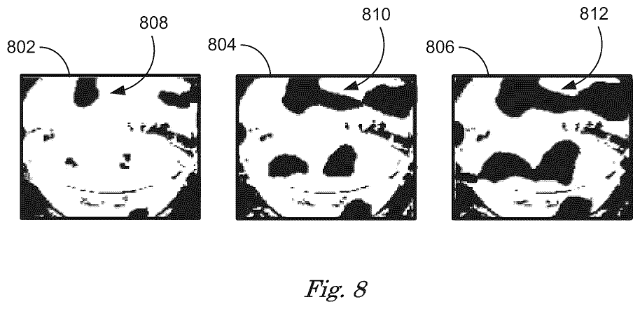

FIG. 8 is an example diagram of three images 802, 804, 806 that include Perlin noise. Image 802 includes Perlin noise generated with parameters size=0.125, sharpness=5. Image 804 includes Perlin noise generated with parameters size=0.125, sharpness=10. Image 806 includes Perlin noise generated with parameters size=0.125, sharpness=20. Perlin noise images 802, 804, 806 can be combined with images from a training dataset 606 to generate images for retraining a machine learning system 500 to output confidence values that the input image is inside a camera lens soiling ODD.

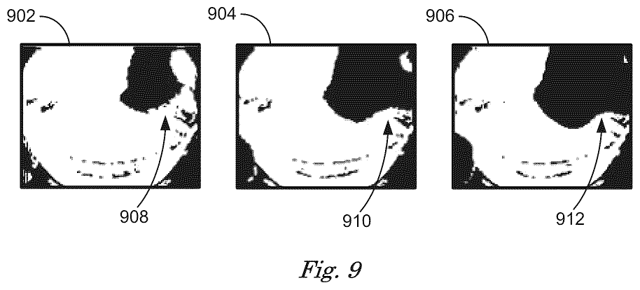

FIG. 9 is an example diagram of three images 902, 904, 906 that include Perlin noise. Image 902 includes Perlin noise generated with parameters size=0.25, sharpness=5. Image 904 includes Perlin noise generated with parameters size=0.25, sharpness=10. Image 906 includes Perlin noise generated with parameters size=0.25, sharpness=20. Perlin noise images 902, 904, 906 can be combined with images from a training dataset 606 to generate images for retraining a machine learning system 500 to output confidence values that the input image is inside a camera lens soiling ODD.

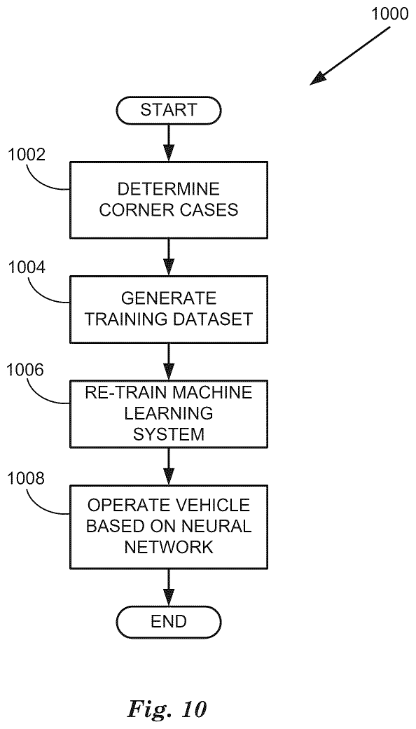

FIG. 10 is a flowchart diagram of a process 1000 for retraining a trained machine learning system 500 to determine a confidence value that an input image is inside a camera lens soiling ODD. Process 1000 can be implemented as hardware and software executing on a server computer 120 to retrain the machine learning system 500 and then transmitting the retrained machine learning system 612 to a computing device 115 included in a vehicle 110 to operate the vehicle. Process 1000 includes multiple blocks that can be executed in the illustrated order. Process 1000 could alternatively or additionally include fewer blocks and can include the blocks executed in different orders.

Process 1000 begins at block 1002, where a training dataset is tested using a trained machine learning system 500 to determine camera lens soiling ODD corner cases as discussed above in relation to FIG. 6. Corner cases can also be determined using an object detection model to output samples that perform poorly on the model. As described above, corner cases are images that include camera soiling noise at the lowest values as defined by Perlin noise parameters that cause the image to underperform on object detection by a trained machine learning system 500. Not all samples that the object detection model underperforms on are outside the ODD. The process of disambiguating ODD underperformances from poor performance by the machine learning system can be done either by an automated system as discussed above or by human intervention.

At block 1004 the Perlin noise parameters included in the corner case images are used to generate a camera lens soiling ODD training dataset 608 as described above in relation to FIG. 6.

At block 1006, the camera lens soiling ODD training dataset 608 is used to retrain a machine learning system 500 previously trained to detect objects in image data as described above in relation to FIG. 6. The retrained machine learning system 512 can, in response to an input image, output a confidence value that the input image is inside the camera lens soiling ODD in addition to predictions regarding one or more of an object's identity, location, size, and orientation.

Next, at block 1008, the retrained machine learning system 612 can be transmitted, downloaded, and/or installed to a computing device 115 in a vehicle 110. Retrained machine learning system 612 can receive images acquired by vehicle sensors and use the predictions regarding object's identity, location, size and orientation to operate the vehicle when the retrained machine learning system 612 outputs a confidence value for the input image being inside the camera lens soiling ODD that is inside a predetermined value, for example 90%. When the confidence value is greater than the predetermined value, computing device 115 can determine a vehicle path based on one or more of the identity, location, size and orientation of an object in the environment around vehicle 110 and actuate vehicle components via controllers 112, 113, 114 to operate vehicle 110 on the vehicle path. The object can be another vehicle, for example. Following block 1108 process 1000 ends.

Any action taken by a vehicle or user of the vehicle in response to one or more navigation prompts disclosed herein should comply with all rules and regulations specific to the location and operation of the vehicle (e.g., Federal, state, country, city, etc.). More so, any navigation prompts disclosed herein are for illustrative purposes only. Certain navigation prompts may be modified and omitted depending on the context, situation, and applicable rules and regulations. Further, regardless of the navigation prompts, users should use good judgement and common sense when operating the vehicle. That is, all navigation prompts, whether standard or “enhanced,” should be treated as suggestions and only followed when prudent to do so and when in compliance with any rules and regulations specific to the location and operation of the vehicle.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
generate a training dataset that includes images that are outside an operational design domain of a machine learning system by modifying the images by adding Perlin noise, wherein the machine learning system is trained to detect an object in an acquired image; and
retrain the machine learning system to output a confidence value greater than a threshold when an image is determined to be inside the operational design domain based on the generated training dataset.

2. The system of claim 1, wherein the operational design domain of the machine learning system includes environmental conditions included in the images received by the machine learning system.

3. The system of claim 2, wherein the environmental conditions include background, weather, lighting, and noise.

4. The system of claim 3, wherein the environmental conditions included in the image are inside the operational design domain when the machine learning system can detect the object.

5. The system of claim 4, wherein the environmental conditions included in the image are outside the operational design domain when the machine learning system does not detect the object.

6. The system of claim 1, wherein the Perlin noise is used to simulate camera lens soiling.

7. The system of claim 1, wherein the operational design domain is determined by testing the machine learning system using images that include camera lens soiling that is inside the operational design domain and camera lens soiling that is outside the operational design domain.

8. The system of claim 1, wherein the machine learning system is a convolutional neural network that includes convolutional layers and fully connected layers.

9. The system of claim 1, wherein statistical distributions of parameters that describe the distributions of Perlin noise parameters including one or more of splotch size, splotch sharpness, splotch transparency and color are used to determine camera lens soiling included in a training dataset.

10. The system of claim 9, wherein the statistical distributions of parameters that describe the distributions of Perlin noise is determined by gradient descent.

11. The system of claim 1, further comprising a second computer included in a vehicle that is programmed to execute the retrained machine learning system to receive the acquired image from a sensor included in a vehicle and determine a confidence value regarding the operational design domain and detect the object.

12. The system of claim 11, wherein the second computer included in the vehicle is programmed to operate the vehicle based on the detected object.

13. A method, comprising:
generating a training dataset that includes images that are outside an operational design domain of a machine learning system by modifying the images by adding Perlin noise, wherein the machine learning system is trained to detect an object in an acquired image; and
retrain the machine learning system to output a confidence value greater than a threshold when and image is determined to be inside the operational design domain based on the generated training dataset.

14. The method of claim 13, wherein the operational design domain of the machine learning system includes environmental conditions included in the images received by the machine learning system.

15. The method of claim 14, wherein the environmental conditions include background, weather, lighting, and noise.

16. The method of claim 15, wherein the environmental conditions included in the image are inside the operational design domain when the machine learning system can detect the object.

17. The method of claim 16, wherein the environmental conditions included in the image are outside the operational design domain when the machine learning system does not detect the object.

18. The method of claim 13, wherein the Perlin noise is used to simulate camera lens soiling.

19. The method of claim 13, wherein the operational design domain is determined by testing the machine learning system using images that include camera lens soiling that is inside the operational design domain and camera lens soiling that is outside the operational design domain.

20. The method of claim 13, wherein the machine learning system is a convolutional neural network that includes convolutional layers and fully connected layers.
